(19) United States
(12) Patent Application Publication
(10) Pub. No.: US 2017/0288968 A1
(43) Pub. Date: Oct. 5, 2017

(54) COMPILING NETWORK POLICIES

(71) Applicant: HEWLETT PACKARD ENTERPRISE DEVELOPMENT LP, Houston, TX (US)

(72) Inventors: Duane Edward Mentze, Roseville, CA (US); Charles F. CLARK, Roseville, CA (US); Shaun WACKERLY, Roseville, CA (US)

(21) Appl. No.: 15/507,489

(22) PCT Filed: Mar. 23, 2015
(86) PCT No.: PCT/US2015/022068

§ 371 Date: Feb. 28, 2017

(51) Int. Cl. H04L 12/24; H04L 29/06

(52) U.S. Cl. CPC H04L 41/0893; H04L 69/03; H04L 41/12; H04L 41/20

(57) ABSTRACT

Example implementations relate to compiling network policies. In an example, a method includes dividing a plurality of network policies into an exclusive policy group and a non-exclusive policy group, compiling the policies in the exclusive policy group into a first plurality of orthogonal policies, compiling the policies in the non-exclusive policy group into at least a second plurality of orthogonal policies, where the compiling of each policy group occurs separately.

### BACKGROUND

Networks can include a plurality of resources connected by communication links, and can be used to connect people, provide services (e.g., internally and/or externally via the Internet and/or intranet), and/or organize information, among other activities associated with an entity. An example network can include a software-defined network (SDN).

### BRIEF DESCRIPTION OF THE DRAWINGS

FIG. 1a illustrates a flow chart of an example method for compiling policies, according to an example.

FIG. 1b illustrates a flow chart of an example method for compiling policies, according to an example.

FIG. 1c illustrates a flow chart of an example method for implementing compiled policies, according to an example.

FIG. 2 illustrates an example environment with devices for compiling and implementing policies, according to an example.

FIG. 3 illustrates an example computer for compiling and implementing policies, according to an example.

### DETAILED DESCRIPTION

Example implementations relate to compiling network policies. In an example, a method includes dividing a plurality of network policies into an exclusive policy group and a non-exclusive policy group, compiling the policies in the exclusive policy group into a first plurality of orthogonal policies, and compiling the policies in the non-exclusive policy group into at least a second plurality of orthogonal policies, where the compiling of each policy group occurs separately.

Networks can include a plurality of resources such as network devices and databases to connect endpoint devices via communication links. Networks can be used to connect people, provide services (e.g., internally and/or externally via the Internet and/or intranet), and organize information, among other activities. Examples of endpoint devices include computers, tablets, phones, printers, cameras, door locks, HVAC controller, among other endpoint devices capable of operating on a network. An example network can include a software-defined network (SDN).

SDN controllers can direct network devices such as servers, SDN-capable switches and routers, and other computing devices, on how to forward network traffic. SDN applications may execute on or interface with the SDN controller to provide input to the SDN controller and influence how the SDN controller forwards traffic. SDN applications might provide services on the network, including observing network traffic and conditions and taking one or more actions as a result. For instance, one application may look for infected hosts on the network, while another application may attempt to optimize voice over internet protocol (VoIP) calls on the network. Both applications may run on the same SDN controller, and use the SDN controller to communicate down to network devices in a protocol-specific format, such as according to the OpenFlow protocol.

When applications within a network, such as an SDN, want to tell the same devices in the network what to do, a conflict may arise between the instructions of one application and the instructions of another application with respect to the same endpoint device. In such instances, the SDN controller may be unable to determine which actions from which applications should be executed, and/or if the instructions of both applications should be executed.

Instructions from applications may be characterized as network policies to be applied to the network. Network policies from different applications may be compiled together to yield a cohesive set of non-overlapping policies to be applied to the network. This set of non-overlapping policies are referred to herein as “orthogonal policies”. An orthogonal policy is a policy generated from one or more original/source policies (e.g., policies that are received from an application) that does not conflict with any other orthogonal policy in a set of orthogonal policies. This means that all policies from the source set of policies to be applied to any single packet in the network would be implemented by a single orthogonal policy. These orthogonal policies may then be transformed into instructions for implementation by network devices. PCT Application No. US2015/015122, entitled “Network Policy Conflict Detection and Resolution” and filed on Feb. 10, 2015, which is hereby incorporated by reference, describes in further detail how policies may be compiled in this manner.

Brute force compilation of logical terms of network policies includes the evaluation of how those terms overlap. As an example, if policy A requires that traffic from all wireless devices be sent to an intrusion prevention system and policy B requires that devices associated with an employee be given a particular priority level, the terms of policy A and policy B overlap in the case where an employee connects to the network with a wireless device. In general, the processing required to evaluate all overlaps is exponential in nature, and depends on the number of terms and the number of policies.

Therefore, policy compilation complexity can be exponential in nature for brute force implementations. The magnitude of such processing is a function of the number of policies and can be represented using big O notation as follows:

PCC=˜O(p^{x})

where PCC is policy compilation complexity, p is the number of policies, and x is a value that depends on the particular compiler algorithm used by the policy engine compiler. As a result, policy compilation can use a significant number of resources and time, potentially resulting in poor network performance and creating issues if a new policies are not able to be implemented quickly enough due to the compilation time. In addition, when policies are compiled together in a brute force manner, a large number of instructions are generated to implement those policies since in general the orthogonal policies increase in complexity as the number of source policies increases.

As described herein, by grouping policies into multiple groups and compiling the groups separately, the compilation complexity can be reduced. Furthermore, by dividing the policies into groups according to certain characteristics, as described below, it can be ensured that appropriate actions from the source polices are applied to any given packet. Finally, the number of instructions to implement the policies may be reduced, simplifying the implementation of the policies at the network device level.

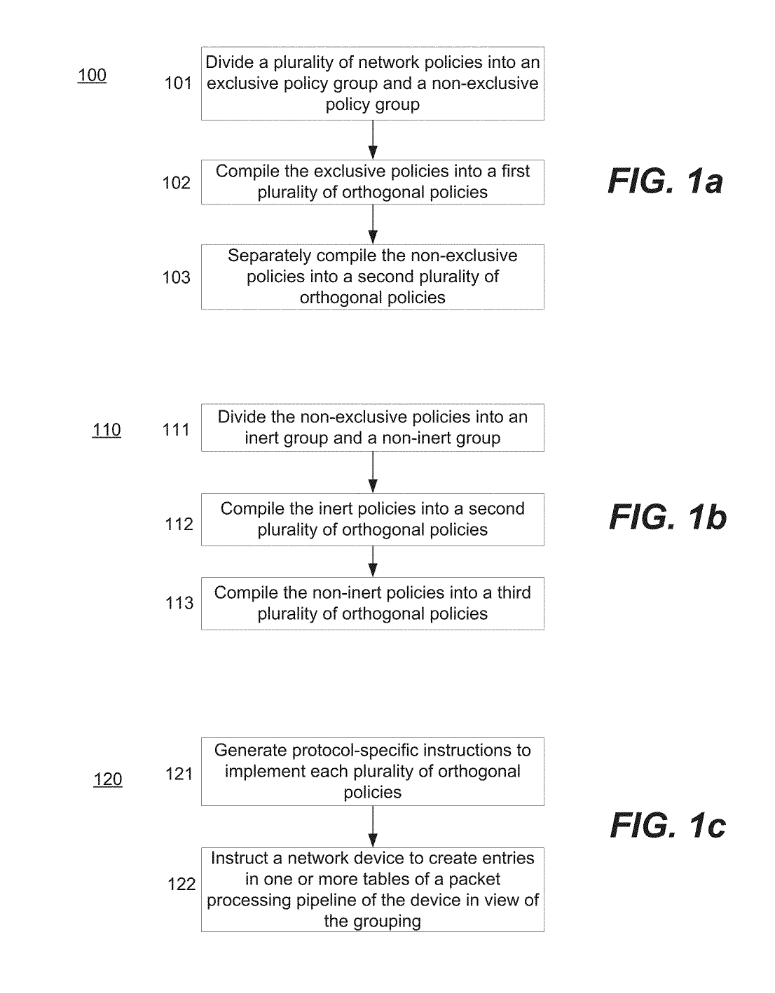

FIGS. 1a-c illustrate methods to compile and implement policies, according to an example. Methods 100, 110, and 120 may be performed by a computing device, computer, server, or the like, such as SDN controller 210 or computer 310. In some examples, network device 220 may be configured to perform these methods. Computer-readable instructions for implementing methods 100, 110, and 120 may be stored on a computer readable storage medium. These instructions as stored on the medium are referred to herein as “modules” and may be executed by a computer.

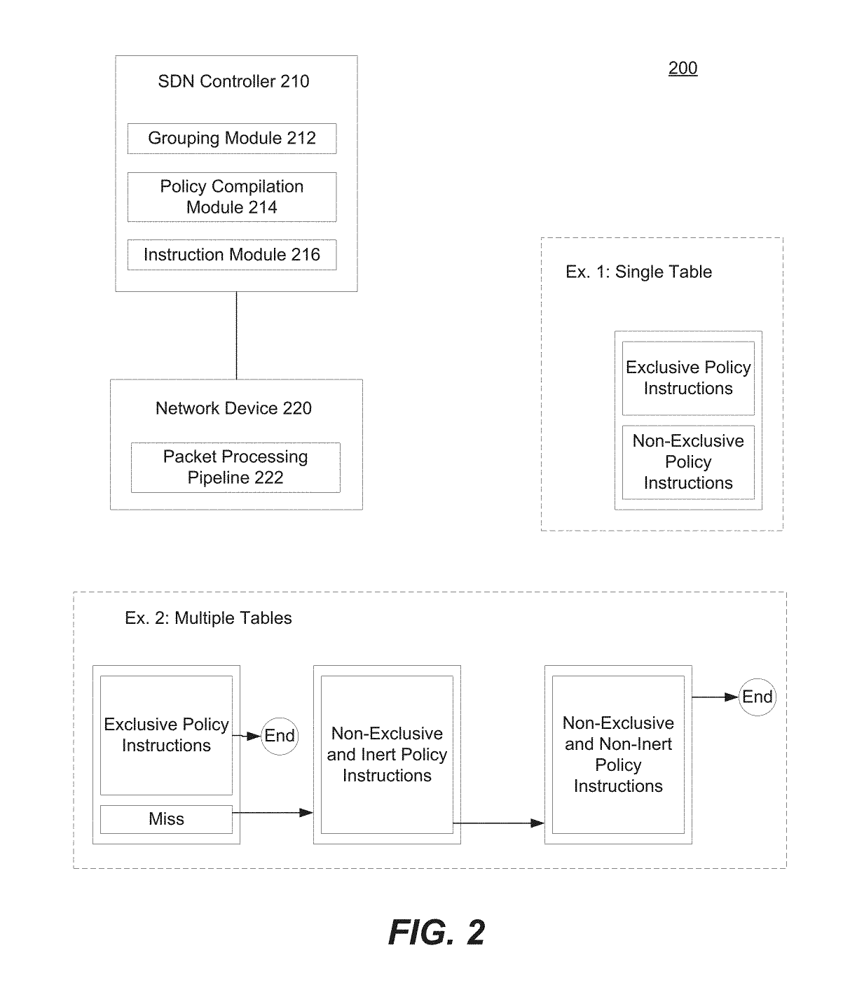

Methods 100, 110, and 120 will be described here relative to environment 200 of FIG. 2. Environment 200 may include SDN controller 210 and network device 220. SDN controller 210 may be a computer configured to manage the control plane of a software defined network. SDN controller 210 may include/be implemented by one or multiple computers. Network device 220 may be a network infrastructure device, such as a switch or router, of the software defined network. The network device 220 may thus be part of the data plane of the software defined network, which may include multiple network devices. SDN controller 210 may communicate with network device 220 via an SDN protocol, such as the OpenFlow protocol. SDN controller 210 may program rules in the packet processing pipeline 222 of network device 220. Network device 220 may use these rules to process and forward network traffic. Additionally, a variety of SDN applications may run on or interface with SDN controller 210. These SDN applications may be part of the application plane of the software defined network.

SDN controller 210 and network device 220 may include one or more controllers and one or more machine-readable storage media. A controller may include a processor and a memory for implementing machine readable instructions. The processor may include at least one central processing unit (CPU), at least one semiconductor-based microprocessor, at least one digital signal processor (DSP) such as a digital image processing unit, other hardware devices or processing elements suitable to retrieve and execute instructions stored in memory, or combinations thereof. The processor can include single or multiple cores on a chip, multiple cores across multiple chips, multiple cores across multiple devices, or combinations thereof. The processor may fetch, decode, and execute instructions from memory to perform various functions. As an alternative or in addition to retrieving and executing instructions, the processor may include at least one integrated circuit (IC), other control logic, other electronic circuits, or combinations thereof that include a number of electronic components for performing various tasks or functions.

The controller may include memory, such as a machine-readable storage medium. The machine-readable storage medium may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium can be computer-readable and non-transitory. Additionally, SDN controller 210 and device 220 may include one or more machine-readable storage media separate from the one or more controllers.

Turning to FIG. 1a, method 100 may be used to compile policies, according to an example. At 101, the SDN controller 210 may divide a plurality of network policies into an exclusive policy group and a non-exclusive policy group. For example, the grouping module 212 may perform this task. The plurality of network policies may be received from various sources. For example, the network policies may be received from SDN applications running on or interfacing with SDN controller 210.

Exclusive policies are policies with associated actions that cannot be combined with the actions of any other policy. For example, a policy may require that all network traffic of a certain type be quarantined and not otherwise be processed. Such a policy is an exclusive policy as the point of the policy is to dictate all processing for that particular type of traffic. In this case, the purpose of the exclusive policy may be to provide network security. Thus, the actions of that policy should not be combined with the actions of any other policy, whether that other policy is an exclusive policy or non-exclusive policy. This is thus a constraint that would be applied during the compilation process of the exclusive policy group, so that two policies with actions intended for the same type of network traffic are not combined. For this reason, exclusive policies can be grouped separately from non-exclusive policies and also compiled separately, since the exclusive policy would always take precedence. Of course, it may be possible for two exclusive policies to relate to the same type of network traffic. In such a case, the exclusive policy with the higher priority takes precedence, and the other exclusive policy would not be applied. The SDN application responsible for the policy can designate whether the policy is exclusive and can also indicate the priority level of the policy.

In contrast, non-exclusive policies are policies with associated actions that can be combined with the actions of other policies. For example, policy A may require a first action to be applied to a type of network traffic and policy B may require a second action to be applied to that same type of network traffic, each of which are not inconsistent with each other. Accordingly, because the policy actions are not mutually exclusive and can both be applied to the same network traffic, when compiling non-exclusive policies there is no need to impose the constraint that actions from two different policies cannot be applied to the same network traffic. For this reason, non-exclusive policies can be grouped together for compilation separate from the compilation of exclusive policies.

In light of this, the grouping module 212 divides the plurality of policies into an exclusive policy group and a non-exclusive policy group. At 102, the SDN controller 210 may compile the exclusive policies (the policies in the exclusive policy group) into a first plurality of orthogonal policies. For example, policy compilation module 214 can perform this task as described in PCT Application No. US2015/015122. Similarly, at 103 the SDN controller 210 may separately compile the non-exclusive policies into a second plurality of orthogonal policies. The policy groups may be compiled separately by SDN controller 210 in various ways. For example, SDN controller 210 may compile the policy groups at different times, using different processing resources, or both. As a result, assuming that there is at least one policy in each group, the policy compilation complexity is reduced because the number of policies in each group is less than the total number of policies. This reduction in complexity is illustrated by the following equation using big 0 notation:

PCC=O(2^{x}+2^{y})<O(2^{x+y})

where PCC is policy compilation complexity, x is the number of policies in the exclusive policy group, and y is the number of policies in the non-exclusive policy group.

Turning to method 120 of FIG. 1c, at 121 SDN controller 210 may generate protocol-specific instructions to implement each of the plurality of orthogonal policies. For example, policy compilation module 214 can perform this task as described in PCT Application No. US2015/015122. Thus, a first plurality of protocol-specific instructions may be generated for the first plurality of orthogonal policies (corresponding to the exclusive policy group), and a second plurality of protocol-specific instructions may be generated for the second plurality of orthogonal policies (corresponding to the non-exclusive policy group). The protocol-specific instructions may be instructions in accordance with a protocol supported by network device 220, such as the OpenFlow protocol. The protocol-specific instructions may thus be instructions suitable for the network device 220 to implement the policies when processing and forwarding traffic. In particular, the protocol-specific instructions may be instructions for creating or modifying flow entries in flow tables in the packet processing pipeline 222, where the flow tables are consulted to determine how to process and forward a received packet.

At 122, SDN controller 210 may instruct network device 220 to create entries in one or more tables of packet processing pipeline 222 in view of the grouping. For example, instruction module 216 may perform this task. In some cases, packet processing pipeline 222 may have only a single table available. This is shown in FIG. 2 as “Ex. 1: Single Table”. In such a case, the network device 220 is instructed to place the first plurality of protocol-specific instructions first in the table (“Exclusive Policy Instructions”) and the second plurality of protocol-specific instructions next in the table (“Non-Exclusive Policy Instructions”). In particular, network device 220 is instructed to create a plurality of entries in the table in accordance with the instructions. This is so that the exclusive policy instructions are given priority over the non-exclusive policy instructions, such that if a packet is matched to an exclusive policy entry, the table processing ceases and there is no opportunity for a non-exclusive policy action (or a lower priority exclusive policy action) to be applied to the packet.

On the other hand, if network device 220 has multiple tables available in its packet processing pipeline 222, as shown in FIG. 2 as “Ex. 2: Multiple Tables”, an additional optimization may be applied as described now with reference to method 110 of FIG. 1b.

Prior to beginning processing in accordance with method 120, method 110 may be performed. Method 110 modifies block 103 of method 100. At 111, SDN controller 210 may divide the non-exclusive policies (from the non-exclusive policy group) into an inert group and a non-inert group. Inert policies are policies are policies that do not change a packet the policy is applied to or alter the packet's delivery to an intended destination. A non-inert policy is a policy that does change a packet the policy is applied to or alter the packet's delivery to an intended destination. For example, a policy that directs the network device 220 to change a value in the header field of a packet would be a non-inert policy because the packet is being changed as a result of the policy. Similarly, a policy that blocks a packet does not change the packet but does prevent the packet from being forwarded to its intended destination, and is thus also a non-inert policy. In contrast, a policy that simply copies the packet or collects statistics related to the packet would be an inert policy because the packet is not being changed and its delivery to the intended destination is not being altered. Because of this difference, inert policies can be separately compiled from non-inert policies. However, as described below, inert policy actions should be applied to a packet before non-inert policy actions are applied.

At 112, SDN controller 210 may compile the inert policies into a second plurality of orthogonal policies. At 113, SDN controller 210 may compile the non-inert policies into a third plurality of orthogonal policies. As before, the compilation of each group may occur separately, thus reducing policy compilation complexity.

Moving to method 120, in addition to the protocol-specific instructions for the plurality of orthogonal policies corresponding to the exclusive policies, at 121 protocol-specific instructions may be generated for the plurality of orthogonal policies corresponding to the non-exclusive, inert policies and for the plurality orthogonal policies corresponding to the non-exclusive, non-inert policies. At 122, SDN controller 210 may instruct network device 220 to create entries in the multiple tables of packet processing pipeline 222. In particular, with reference to “Ex. 2: Multiple Tables”, entries may be created for the exclusive policy instructions in a first table, entries may be created for the non-exclusive, inert policy instructions in a second table, and entries may be created for the non-exclusive, non-inert policy instructions in a third table. When network device 220 receives a packet, device 220 may first attempt to match the packet to an entry in the first table. If there is a match, table processing may cease (“End”). If there is no match (“Miss”), it may attempt to match the packet to an entry in the second table. Even if there is a match in the second table, device 220 may still attempt to match the packet to an entry in the third table. In this way, both the inert policy actions and the non-inert policy actions can be applied to the packet.

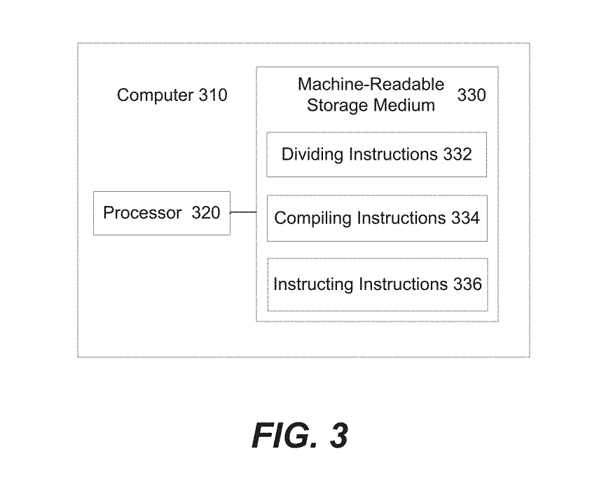

FIG. 3 illustrates a computer to compile and implement policies, according to an example. Computer 310 may be part of SDN controller 210 or network device 220. The computer may include one or more controllers and one or more machine-readable storage media, as described with respect to SDN controller 210 and network device 220, for example.

Processor 320 may be at least one central processing unit (CPU), at least one semiconductor-based microprocessor, other hardware devices or processing elements suitable to retrieve and execute instructions stored in machine-readable storage medium 330, or combinations thereof. Processor 320 can include single or multiple cores on a chip, multiple cores across multiple chips, multiple cores across multiple devices, or combinations thereof. Processor 320 may fetch, decode, and execute instructions 332-336 among others, to implement various processing. As an alternative or in addition to retrieving and executing instructions, processor 320 may include at least one integrated circuit (IC), other control logic, other electronic circuits, or combinations thereof that include a number of electronic components for performing the functionality of instructions 332-336. Accordingly, processor 320 may be implemented across multiple processing units, and instructions 332-336 may be implemented by different processing units in different areas of computer 310.

Machine-readable storage medium 330 may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium 330 can be computer-readable and non-transitory. Machine-readable storage medium 330 may be encoded with a series of executable instructions for managing processing elements.

The instructions 332-336 when executed by processor 320 (e.g., via one processing element or multiple processing elements of the processor) can cause processor 320 to perform processes, for example, methods 100, 110, and 120, and/or variations and portions thereof. Instructions 332-336 will now be briefly described, which description should be read in light of the description of methods 100, 110, 120, and environment 200 above.

Computer 310 may compile and implement policies. For example, dividing instructions 332 may cause processor 320 to divide a plurality of network policies into an exclusive policy group and a non-exclusive policy group. Compiling instructions 334 may cause processor 320 to compile the policies in the exclusive policy group into a first plurality of orthogonal policies. Compiling instructions 334 may additionally cause processor 320 to compile the policies in the non-exclusive policy group into a second plurality of orthogonal policies. The compiling of the two groups may be performed separately. Compiling instructions 334 may additionally cause processor 320 to generate protocol-specific instructions for each plurality of orthogonal policies. Instructing instructions 336 may instruct a network device to create entries in a table of a packet processing pipeline of the device to implement the instructions, such that the entries corresponding to the exclusive policy instructions are given precedence over the entries corresponding to the non-exclusive policy instructions.

In the present disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor. Further, as used herein, “a” or “a number of” something can refer to one or more such things. For example, “a number of widgets” can refer to one or more widgets. Also, as used herein, “a plurality of” something can refer to more than one of such things.

The above specification, examples and data provide a description of the method and applications, and use of the system and method of the present disclosure. Since many examples can be made without departing from the spirit and scope of the systems and methods of the present disclosure, this specification merely sets forth some of the many possible embodiments, configurations, and implementations.

What is claimed is:

1. A method for compiling network policies, comprising, by a processor:
dividing a plurality of network policies into an exclusive policy group and a non-exclusive policy group;
compiling the policies in the exclusive policy group into a first plurality of orthogonal policies;
compiling the policies in the non-exclusive policy group into at least a second plurality of orthogonal policies,
the compiling of each policy group occurring separately.

2. The method of claim 1, further comprising:
generating a first plurality of protocol-specific instructions to implement the first plurality of orthogonal policies; and
generating a second plurality of protocol-specific instructions to implement the second plurality of orthogonal policies.

3. The method of claim 2, further comprising:
instructing a network device to create a first plurality of entries in a table of a packet processing pipeline of the network device according to the first plurality of protocol-specific instructions; and
instructing the network device to create a second plurality of entries in the table according to the second plurality of protocol-specific instructions,
such that the first plurality of entries are given priority over the second plurality of entries in the packet processing pipeline.

4. The method of claim 3, wherein the processor is part of a controller in a software defined network, the network device is a SDN-enabled switch, and the controller communicates with the network device in accordance with the OpenFlow protocol.

5. The method of claim 1, further comprising:
dividing the policies in the non-exclusive policy group into an inert policy group and a non-inert policy group;
compiling the policies in the inert policy group into the second plurality of orthogonal policies; and
compiling the policies in the non-inert policy group into a third plurality of orthogonal policies,
the compiling of each group occurring separately.

6. The method of claim 5, comprising:
generating a first plurality of protocol-specific instructions to implement the first plurality of orthogonal policies;
generating a second plurality of protocol-specific instructions to implement the second plurality of orthogonal policies; and
generating a third plurality of protocol-specific instructions to implement the third plurality of orthogonal policies.

7. The method of claim 6, comprising:
instructing a network device to create a first plurality of entries in a first table of a packet processing pipeline of the network device according to the first plurality of protocol-specific instructions;
instructing the network device to create a second plurality of entries in a second table of the packet processing pipeline according to the second plurality of protocol-specific instructions; and
instructing the network device to create a third plurality of entries in a third table of the packet processing pipeline according to the third plurality of protocol-specific instructions,
such that the first plurality of entries are given priority over the second plurality of entries, and the second plurality of entries are given priority over the third plurality of entries.

8. The method of claim 7, wherein if a packet matches an entry in the first table in the packet-processing pipeline, the network device does not attempt to match the packet to an entry in the second table or the third table.

9. The method of claim 7, wherein if a packet does not match an entry in the first table in the packet-processing pipeline, the network device attempts to match the packet both to an entry in the second table and to an entry in the third table.

10. A controller in a software defined network (SDN), comprising:
a grouping module to group a plurality of network policies into an exclusive policy group and a non-exclusive policy group; and
a policy compilation module to:
compile the policies in the exclusive policy group into a first plurality of orthogonal policies, and
compile the policies in the non-exclusive policy group into at least a second plurality of orthogonal policies,
the policy compilation module performing the compilation of each policy group separately.

11. The controller of claim 10,
the grouping module to group the policies in the non-exclusive policy group into an inert policy group and a non-inert policy group,
the policy compilation module to compile the policies in the inert policy group into the second plurality of orthogonal policies and compile the policies in the non-inert policy group into a third plurality of orthogonal policies.

12. The controller of claim 11, wherein an exclusive policy is a policy that cannot be combined with another policy, an inert policy is a policy that does not change a packet the policy is applied to or alter the packet's delivery to an intended destination, and a non-inert policy is a policy that does change a packet the policy is applied to or alter the packet's delivery to an intended destination.

13. The controller of claim 10, wherein an orthogonal policy is a policy generated from one or more policies in the plurality of network polices that does not conflict with any other orthogonal policy, such that polices to be applied to any single packet would be implemented by a single orthogonal policy.

14. The controller of claim 10, wherein at least one of the plurality of network policies is received from an SDN application executing in the SDN.

15. The controller of claim 10, further comprising an instruction module to instruct a network device to add flow entries in accordance with the first plurality of protocol-specific instructions and second plurality of protocol-specific instructions in such a way that the network device attempts to match a received packet to a flow entry in accordance with the first plurality of protocol-specific instructions before the network device attempts to match the received packet to a flow entry in accordance with the second plurality of protocol-specific instructions.

16. A non-transitory computer-readable storage medium storing instructions that, when executed by a processor, cause the processor to:
divide a plurality of network policies into an exclusive policy group and a non-exclusive policy group;
compile the policies in the exclusive policy group into a first plurality of orthogonal policies; and
compile the policies in the non-exclusive policy group into at least a second plurality of orthogonal policies,
the compiling of each policy group occurring separately.
